(19) United States
(12) Patent Application Publication
(10) Pub. No.: US 2017/0121036 A1
(43) Pub. Date: May 4, 2017

(54) GROUND STATION FOR AIRBORNE WIND TURBINE

(71) Applicant: Google Inc., Mountain View, CA (US)

(72) Inventors: Brian Hachtmann, San Marin, CA (US); Damon Vander Lind, Alameda, CA (US)

(21) Appl. No.: 14/929,003

(22) Filed: Oct. 30, 2015

(51) Int. Cl. B64F 3/00; B64F 1/12; F03D 15/20; B64C 31/06; F03D 5/00; F03D 9/00

(52) U.S. Cl. CPC B64F 3/00; F03D 5/00; F03D 9/002; F03D 15/20; B64C 31/06; B64F 1/12

(57) ABSTRACT

An Airborne Wind Turbine (“AWT”) may be used to facilitate conversion of kinetic energy to electrical energy. An AWT may include an aerial vehicle that flies in a path to convert kinetic wind energy to electrical energy. The aerial vehicle may be tethered to an active azimuth ground station. In one aspect, the ground station has platform that is rotatable about an azimuth axis. The platform is coupled to an azimuth slewing bearing that is coupled an azimuth drive motor operable to rotate the platform about the azimuth axis. The platform may be coupled to a winch frame with an interior cavity. The winch frame may be coupled to a winch drum that is rotatable about a central axis. The winch drum may be coupled to a winch drum slewing bearing and a winch drum drive motor operable to rotate the winch drum about the central axis.

### BACKGROUND

Unless otherwise indicated herein, the materials described in this section are not prior art to the claims in this application and are not admitted to be prior art by inclusion in this section.

Power generation systems may convert chemical and/or mechanical energy (e.g., kinetic energy) to electrical energy for various applications, such as utility systems. As one example, a wind energy system may convert kinetic wind energy to electrical energy.

The use of wind turbines as a means for harnessing energy has been used for a number of years. Conventional wind turbines typically include large turbine blades positioned atop a tower. The cost of manufacturing, erecting, maintaining, and servicing such wind turbine towers is significant.

An alternative to the costly wind turbine towers that may be used to harness wind energy is the use of an aerial vehicle that is attached to a ground station with an electrically conductive tether. Such an alternative may be referred to as an energy kite or an Airborne Wind Turbine (AWT).

### SUMMARY

The present disclosure generally relates to ground stations that may be used in an Airborne Wind Turbine (AWT) system that includes an aerial vehicle attached to a ground station by an electrically conductive tether. In particular, the present disclosure relates to an active azimuth drive ground station that may be used in an AWT to facilitate winding and unwinding of an electrically conductive tether at a ground station, as well as to facilitate takeoff and landing of the aerial vehicle. The systems and methods disclosed herein may allow for more reliable, safe, and efficient deployment and reception of aerial vehicles.

In one aspect, a ground station is provided. The ground station includes a tower. The ground station includes a platform that is rotatable relative to the tower via an azimuth slewing bearing. The ground station includes at least one azimuth drive motor coupled to the azimuth slewing bearing and configured to rotate the platform about an azimuth axis. The ground station includes a winch frame coupled to the platform and a winch drum that is rotatable relative to the winch frame via a winch slewing bearing. The ground station also includes at least one winch drive motor coupled to the winch slewing bearing and configured to rotate the winch drum about a central axis. The winch frame may further include an interior cavity configured to house the at least one azimuth drive motor and the at least one winch drive motor.

In another aspect, a ground station system is provided. The system includes a ground station. The ground station includes a tower and a platform that is rotatable relative to the tower via an azimuth slewing bearing. The ground station includes at least one azimuth drive motor coupled to the azimuth slewing bearing and configured to rotate the platform about an azimuth axis. The ground station includes a winch frame coupled to the platform and a winch drum that is rotatable relative to the winch frame via a winch slewing bearing. The ground station also includes at least one winch drive motor coupled to the winch slewing bearing and configured to rotate the winch drum about a central axis. The winch drum may further include an exterior winding surface with a continuous groove. The winch drum may further include a conical interior surface forming a boundary of an interior drum cavity. The system may further include a tether adapted to be wound about the winch drum and accumulated in the continuous groove of the exterior winding surface when the winch drum is rotated in a first direction about the central axis.

In another aspect, a ground station system is provided. The system includes a ground station. The ground station includes a tower and a platform that is rotatable relative to the tower via an azimuth slewing bearing. The ground station includes at least one azimuth drive motor coupled to the azimuth slewing bearing and configured to rotate the platform about an azimuth axis. The ground station includes a winch frame coupled to the platform and a winch drum that is rotatable relative to the winch frame via a winch slewing bearing. The ground station also includes at least one winch drive motor coupled to the winch slewing bearing and configured to rotate the winch drum about a central axis. The winch drum may further include an exterior winding surface with a continuous groove. The winch drum may further include a fleeting angle groove, where the width of the fleeting angle groove is substantially larger than the width of the continuous groove of the exterior winding surface. The system may further include a tether adapted to be wound about the winch drum and accumulated in the continuous groove of the exterior winding surface when the winch drum is rotated in a first direction about the central axis.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a perspective view of an exemplary airborne wind turbine 10 in a flying mode, including an aerial vehicle 20 attached to a ground station 50 by a tether 30.

FIG. 2 is a close-up perspective view of the aerial vehicle 20 shown in FIG. 1.

FIG. 3 is a side view of an exemplary airborne wind turbine 100 in a non-flying perched mode, including an aerial vehicle 120 attached to a ground station 150 by a tether 130, where the aerial vehicle 120 is perched on a perch panel 160 of the ground station 150.

FIG. 4 is a top view of the airborne wind turbine 100 shown in FIG. 3.

FIG. 5 is a cross-sectional view of an exemplary tether 230, including electrical conductors 292 surrounding a core 290.

FIG. 6 is a cross-sectional view of an exemplary ground station 650.

FIG. 7 depicts an exploded view of a slewing bearing, according to some embodiments.

FIG. 8 is a perspective view of a ground station 850, according to some embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed methods and systems can be arranged and combined in a wide variety of different configurations, all of which are contemplated herein.

Furthermore, all of the Figures described herein are representative only and the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

### I. OVERVIEW

Wind energy systems, such as an Airborne Wind Turbine (AWT), may be used to convert wind energy to electrical energy. An AWT is a wind based energy generation device that may include an aerial vehicle that is attached to a ground station by an electrically conductive tether. The aerial vehicle may be constructed of a rigid wing with a plurality of mounted turbines. The aerial vehicle may be operable to fly in a path across the wind, such as a substantially circular path above the ground (or water) to convert kinetic wind energy to electrical energy. In such crosswind flight, the aerial vehicle may fly across the wind in a circular pattern similar to the tip of a wind turbine blade. The turbines attached to the rigid wing may be used to generate power by slowing the wing down. In particular, air moving across the turbine blades may force the blades to rotate, driving a generator to produce electricity. The aerial vehicle may also be connected to a ground station via an electrically conductive tether that transmits power generated by the aerial vehicle to the ground station, and on to a grid.

When it is desired to land the aerial vehicle, the electrically conductive tether may be wound onto a spool or drum on the ground station and the aerial vehicle may be reeled in towards a perch on the ground station. Prior to landing on the perch, the aerial vehicle transitions from a flying mode to a hover mode. The drum may be further rotated to further wind the tether onto the drum until the aerial vehicle comes to rest on the perch.

The electrically conductive tether may be configured to withstand one or more forces of the aerial vehicle when the aerial vehicle is in flight mode (e.g., takeoff, landing, hover flight, forward flight, and/or crosswind flight). As such, the tether may include a core constructed of high strength fibers. In addition to transmitting electrical energy generated by the aerial vehicle to the ground station, as noted above, the tether may also be used to transmit electricity from the ground station to the aerial vehicle in order to power the aerial vehicle during operation. Accordingly, the tether may also include one or more electrical conductors for the transmission of electrical energy generated by the aerial vehicle and/or transmission of electricity to the aerial vehicle. In some embodiments, the tether may include a plurality of insulated electrical conductors that surround the tether core. In some embodiments, the tether may also include one or more optical conductors for the transmission of data to and from the aerial vehicle.

As the aerial vehicle flies across the wind in a substantially circular path, the tether may continuously rotate in one direction about a central tether axis. Consequentially, a tether termination system may be provided at the ground station that allows for tether rotation. Such a tether termination system may avoid twisting of the tether, which could, among other things, damage the electrical conductors of the tether.

### II. ILLUSTRATIVE AIRBORNE WIND TURBINES

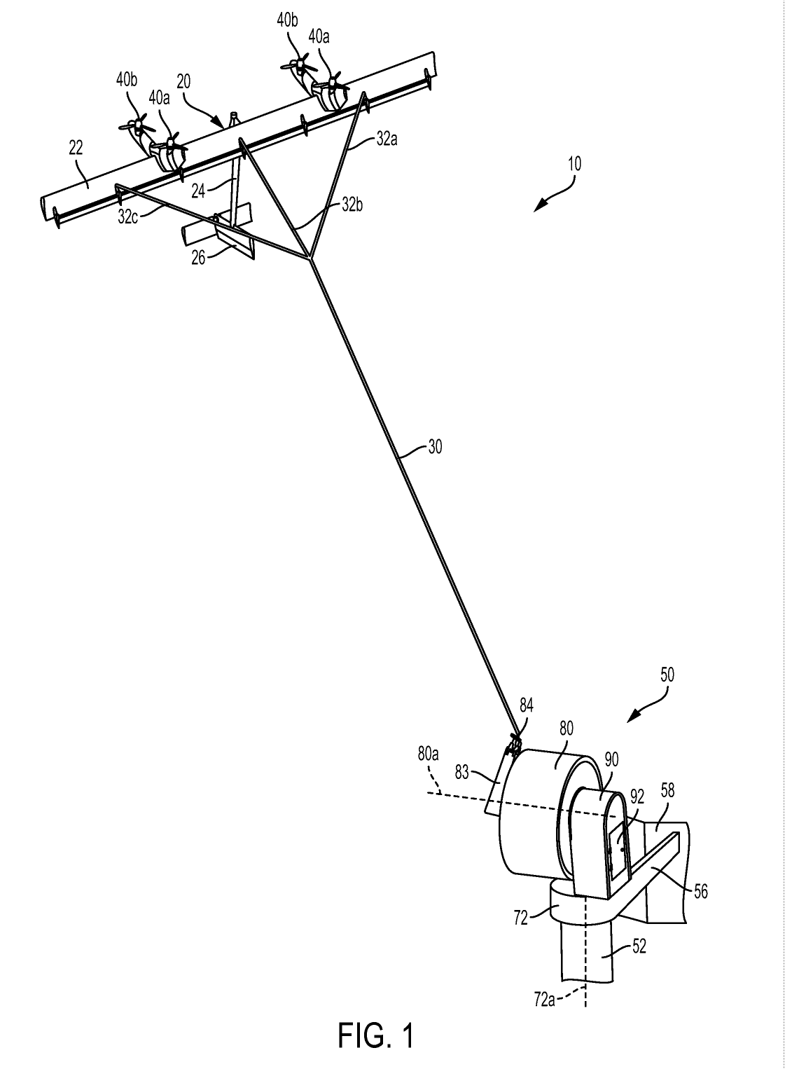

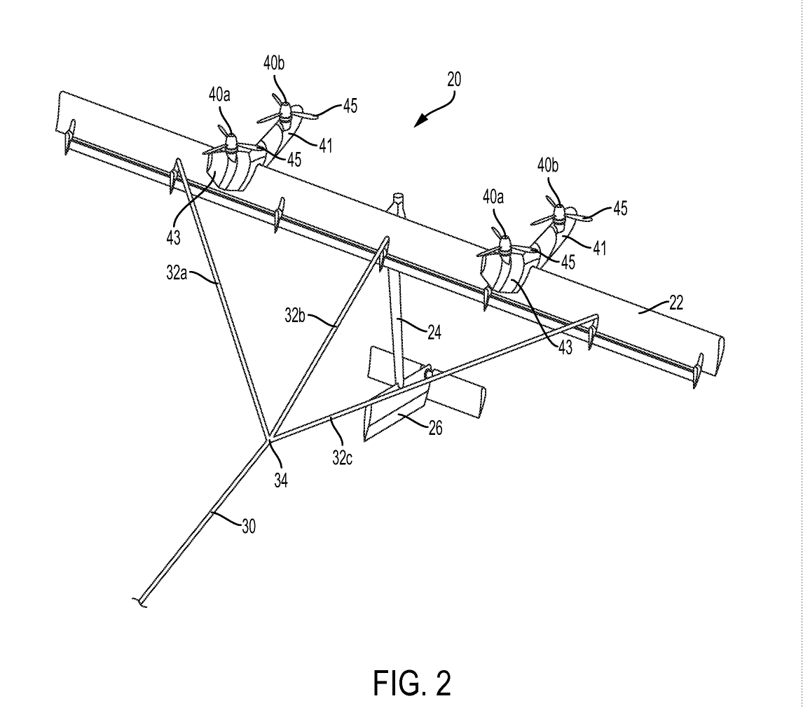

As disclosed in FIGS. 1-2, an Airborne Wind Turbine (AWT) 10 is disclosed, according to an example embodiment. AWT 10 is a wind based energy generation device that includes an aerial vehicle 20 constructed of a rigid wing 22 with mounted turbines (or rotors) 40a and 40b that flies in a path, such as a substantially circular path, across the wind. In an example embodiment, the aerial vehicle 20 may fly between 250 and 600 meters above the ground (or water) to convert kinetic wind energy to electrical energy. However, an aerial vehicle 20 may fly at other heights without departing from the scope of the invention. In crosswind flight, the aerial vehicle 20 flies across the wind in a circular pattern similar to the tip of a wind turbine. The rotors 40a and 40b attached to the rigid wing 22 are used to generate power. Drag forces from air moving across the turbine blades 45 forces them to rotate, driving a generator (not shown) to produce electricity. The aerial vehicle 20 is connected to a ground station 50 via an electrically conductive tether 30 that transmits power generated by the aerial vehicle 20 to the ground station 50, and potentially on to a power grid.

As shown in FIG. 1, the aerial vehicle 20 may be connected to the tether 30, and the tether 30 may be connected to the ground station 50. In this example, the tether 30 may be attached to the ground station 50 at one location on the ground station 50. The tether 30 may be attached to the aerial vehicle 20 at three locations on the aerial vehicle 20 using bridal 32a, 32b, and 32c. However, in other examples, the tether 30 may be attached at a single location or multiple locations to any part of the ground station 50 and/or the aerial vehicle 20.

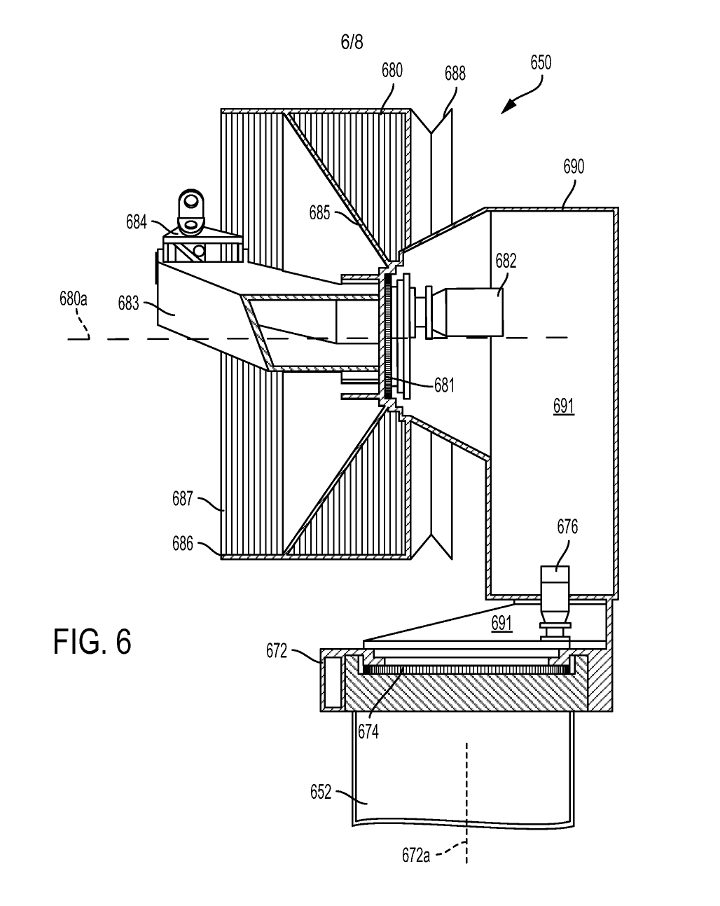

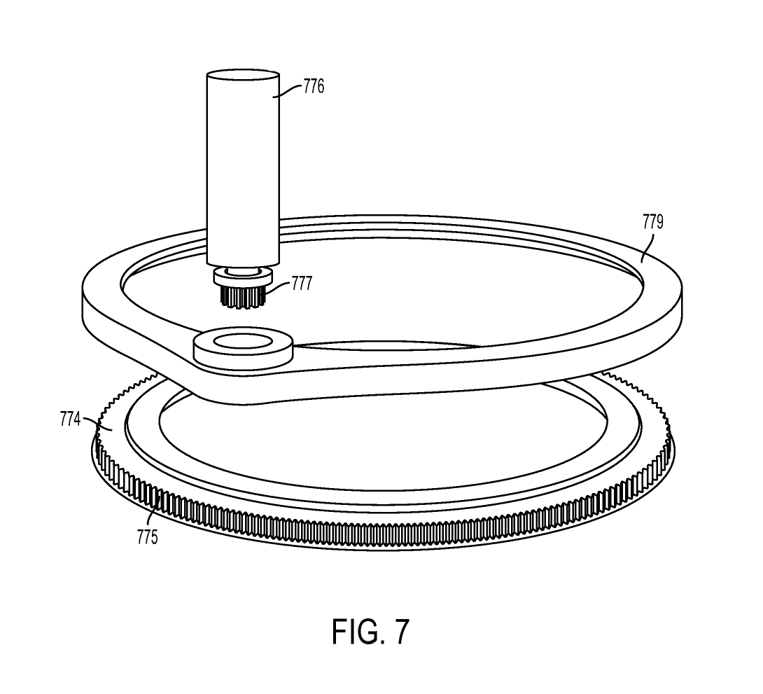

The ground station 50 may be used to hold and/or support the aerial vehicle 20 until it is in an operational mode. The ground station may include a tower 52 that may be on the order of 15 meters tall. The ground station may include a platform 72 that is rotatable relative to the tower 52. For example, a slewing bearing (not shown in FIG. 1 but described further in reference to FIGS. 6 and 7) may be coupled to tower 52 and platform 72. The slewing bearing may be rotated by one or more motors about an axis of rotation, such as the azimuth axis 72a illustrated in FIG. 1. The ground station may also include a winch frame 90. The winch frame may contain an interior cavity (e.g., the interior cavity 691 of winch frame 690 described in reference to FIG. 6), accessible by an aperture (e.g., door 92). The aperture may be sealable such that the interior cavity has some protection from weather and environmental effects (e.g., rain, salt corrosion, etc.).

The ground station may also include a winch drum 80 rotatable about drum central axis 80a that is used to reel in aerial vehicle 20 by winding the tether 30 onto the rotatable drum 80. In this example, the drum 80 is coupled to winch frame 90 and oriented vertically, although the drum may also be oriented horizontally (or at an angle) in some embodiments. Drum 80 may be rotatable relative to winch frame 90. For example, a slewing bearing may couple drum 80 and winch frame 90. The slewing bearing may be rotated by one or more motors about an axis of rotation, such as the drum central axis 80a. A gimbal mount 83 may be coupled to winch drum 80 to mount a gimbal 84. For example, gimbal 84 may be configured to rotate about one or more axes and be coupled to, and/or constrain a portion of, the tether 30.

Further, the ground station 50 may be further configured to receive the aerial vehicle 20 during a landing. For example, at least one support member 56 may extend from platform 72 and support at least one perch panel 58. FIG. 1 illustrates two support members 56 supporting a single perch panel 58, and other variations are possible. Support member(s) 56 may be fixedly attached to platform 72 so that support member(s) 56 and perch panel(s) 58 rotate with the platform. When the tether 30 is wound onto drum 80, and the aerial vehicle 20 is reeled in towards the ground station 50, the aerial vehicle 20 may come to rest upon perch panel 58.

The ground station 50 may be formed of any material that can suitably keep the aerial vehicle 20 attached and/or anchored to the ground while in hover flight, forward flight, or crosswind flight. In some implementations, ground station 50 may be configured for use on land. However, ground station 50 may also be implemented on a body of water, such as a lake, river, sea, or ocean. For example, a ground station could include or be arranged on a floating off-shore platform, a boat, or fixed to a sea floor, among other possibilities. Further, ground station 50 may be configured to remain stationary or to move relative to the ground or the surface of a body of water.

The tether 30 may transmit electrical energy generated by the aerial vehicle 20 to the ground station 50. In addition, the tether 30 may transmit electricity to the aerial vehicle 20 in order to power the aerial vehicle 20 during takeoff, landing, hover flight, and/or forward flight. Further, the tether 30 may transmit data between the aerial vehicle 20 and ground station 50. The tether 30 may be constructed in various forms and using various materials that may allow for the transmission, delivery, and/or harnessing of electrical energy generated by the aerial vehicle 20 and/or transmission of electricity to the aerial vehicle 20. For example, the tether 30 may include one or more electrical conductors. The tether 30 may also be constructed of a material that allows for the transmission of data to and from the aerial vehicle 20. For example, the tether may also include one or more optical conductors.

The tether 30 may also be configured to withstand one or more forces of the aerial vehicle 20 when the aerial vehicle 20 is in an operational mode. For example, the tether 30 may include a core configured to withstand one or more forces of the aerial vehicle 20 when the aerial vehicle 20 is in hover flight, forward flight, and/or crosswind flight. The core may be constructed from various types of high strength fibers and/or a carbon fiber rod. In some embodiments, the tether has a fixed length of 500 meters.

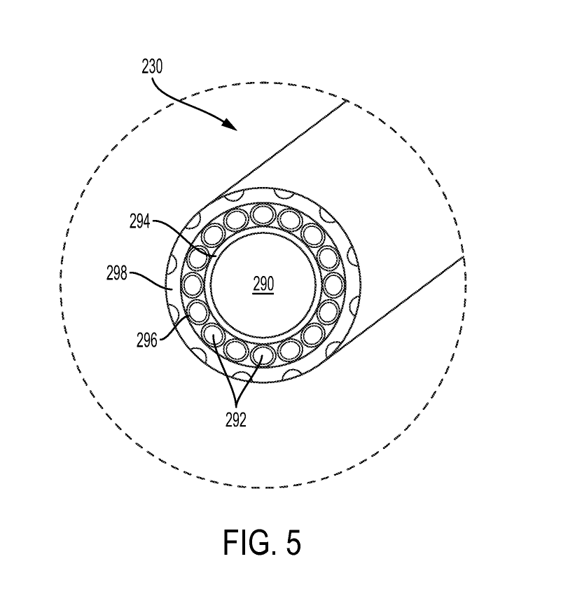

In one embodiment of the tether, as shown in the cross-sectional view of FIG. 5, the tether 230 may include a central high-strength core 290 surrounded by a plurality of electrical conductors 292. The core 290 may comprise a single strand or multiple helically wound strands. In one embodiment, the high-strength core 290 is comprised of multiple composite rods having fibrous elements such as aramid fibers, carbon fibers, or glass fibers, and a constraining matrix element such as an epoxy matrix or a vinyl ester matrix. In another embodiment, the high-strength core 290 is comprised of dry fibers, metal wire, or metal cable rather than composite rods. The tether core 290 may be coated with a bonding layer 294 and each of the electrical conductors 292 may be provided with an insulation jacket 296. An outer sheath 298 may also be provided. Surrounding the tether core 290 with the electrical conductors 292, as opposed to running the conductors through the center of the core, may be desirable because, among other things, it may increase the cooling capacity available to the electrical conductors. In some embodiments, one or more of the electrical conductors may be replaced with one or more optical conductors.

The aerial vehicle 20 may include or take the form of various types of devices, such as a kite, a helicopter, a wing and/or an airplane, among other possibilities. The aerial vehicle 20 may be formed of solid structures of metal, plastic and/or other polymers. The aerial vehicle 20 may be formed of various materials that allow for a high thrust-to-weight ratio and generation of electrical energy which may be used in utility applications. Additionally, the materials may be chosen to allow for a lightning hardened, redundant and/or fault tolerant design which may be capable of handling large and/or sudden shifts in wind speed and wind direction.

As shown in FIG. 1, and in greater detail in FIG. 2, the aerial vehicle 20 may include a main wing 22, rotors 40a and 40b, tail boom or fuselage 24, and tail wing 26. Any of these components may be shaped in any form that allows for the use of components of lift to resist gravity and/or move the aerial vehicle 20 forward.

The main wing 22 may provide a primary lift for the aerial vehicle 20. The main wing 22 may be one or more rigid or flexible airfoils, and may include various control surfaces, such as winglets, flaps, rudders, elevators, etc. The control surfaces may be used to stabilize the aerial vehicle 20, reduce drag, and/or increase drag on the aerial vehicle 20 during hover flight, forward flight, and/or crosswind flight. The main wing 22 may be composed of suitable materials for the aerial vehicle 20 to engage in hover flight, forward flight, and/or crosswind flight. For example, the main wing 20 may include carbon fiber and/or e-glass.

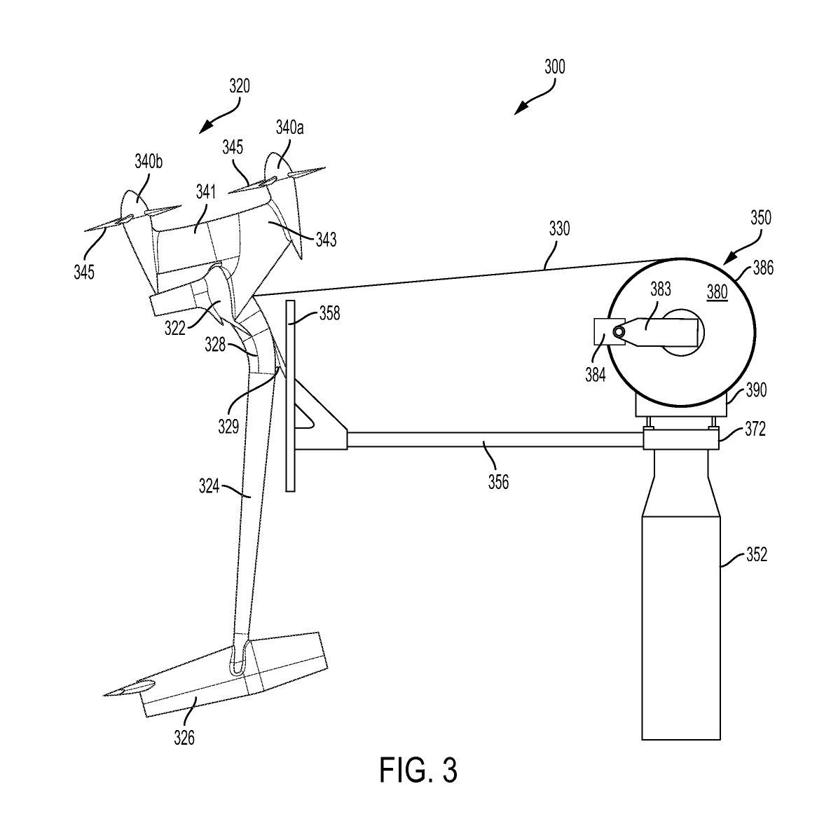

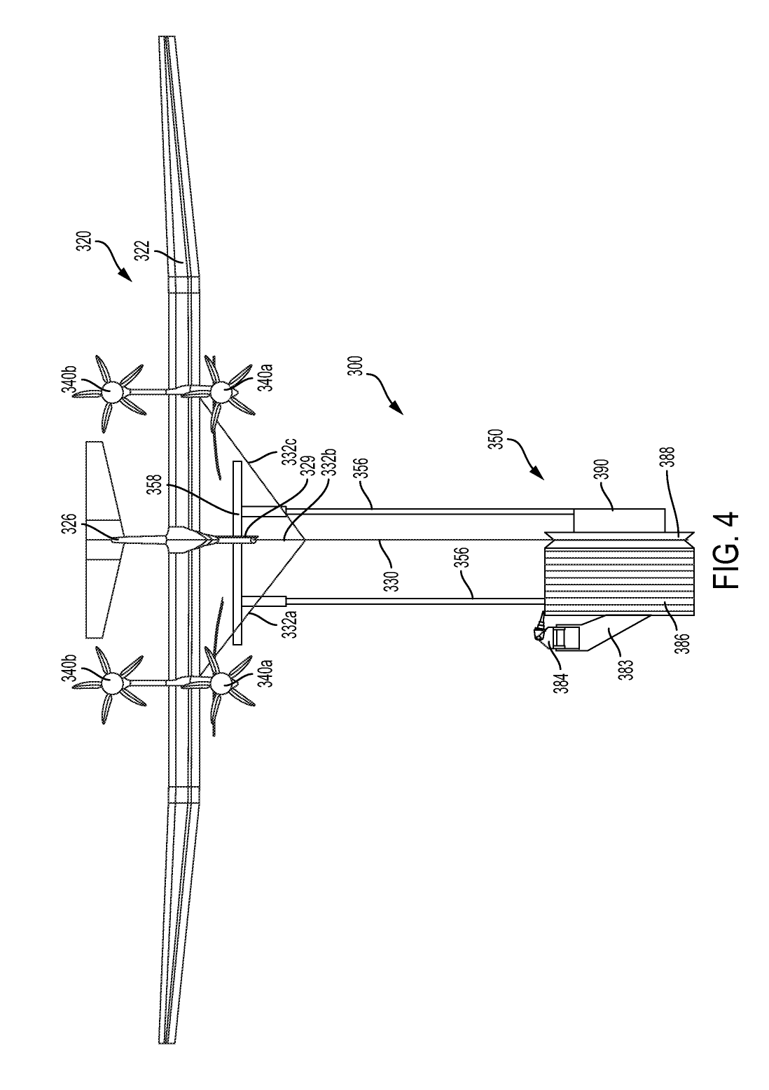

Rotor connectors 43 may be used to connect the lower rotors 40a to the main wing 22, and rotor connectors 41 may be used to connect the upper rotors 40b to the main wing 22. In some examples, the rotor connectors 43 and 41 may take the form of or be similar in form to one or more pylons. In this example, the rotor connectors 43 and 41 are arranged such that the lower rotors 40a are positioned below the wing 22 and the upper rotors 40b are positioned above the wing 22. In another example, illustrated in FIGS. 3-4, rotor connectors 141 and 143 may form a single pylon that may be attached to the underside of the main wing 122. In such an embodiment, rotor connectors 143 and 141 may still be arranged such that the lower rotors 140a are positioned below the wing 122 and the upper rotors 140b are positioned above the wing 122.

The rotors 40a and 40b may be configured to drive one or more generators for the purpose of generating electrical energy. In this example, the rotors 40a and 40b may each include one or more blades 45, such as three blades. The one or more rotor blades 45 may rotate via interactions with the wind and the rotational energy may be used to drive the one or more generators. In addition, the rotors 40a and 40b may also be configured to provide a thrust to the aerial vehicle 20 during flight. With this arrangement, the rotors 40a and 40b may function as one or more propulsion units, such as a propeller, and the generator(s) may function as a motor. Although the rotors 40a and 40b are depicted as four rotors in this example, in other examples the aerial vehicle 20 may include any number of rotors, such as less than four rotors or more than four rotors, e.g. six or eight rotors.

Referring back to FIG. 1, when it is desired to land the aerial vehicle 20, the drum 80 is rotated, causing the electrically conductive tether 30 is wind onto drum 80 and reel in the aerial vehicle 20 towards the perch panels 58 on the ground station 50, and. Prior to landing on the perch panels 58, the aerial vehicle 20 transitions from a flying mode to a hover mode. The drum 80 is further rotated to further wind the tether 30 onto the drum 80 until the aerial vehicle 20 comes to rest on the perch panels 58.

FIG. 3 is a side view of an airborne wind turbine 300, according to an example embodiment. As shown, airborne wind turbine 300 includes aerial vehicle 320 perched on perch panel 358 of ground station 350. FIG. 4 is a top view of the aerial vehicle 320 and ground station 350 shown in FIG. 3, according to an example embodiment. In FIGS. 3 and 4, ground station 350 includes a tower 352 upon which rotatable drum 380 and levelwind 384 are positioned. In some embodiments, the tower 352 may be 15 meters in height. In this perched mode, electrically conductive tether 330 is wrapped around drum 380 and extends from the flanged groove 388, and is attached to wing 322 of aerial vehicle 320 using bridle lines 332a, 332b, and 332c. In some embodiments, a levelwind (not shown) may also be used to help position the tether along the exterior winding surface 386 of the drum. In some embodiments, a levelwind may be unnecessary where a fleeting angle groove is used (e.g., flanged groove 388 illustrated in FIG. 4). References in this application to the fleeting angle refer to the angle of the tether relative to the drum, where a zero degree angle denotes a tether that is perpendicular to the drum central axis 80a.

For example, in some embodiments, a portion of the exterior winding surface 386 of the drum 380 may be a continuous groove of substantially uniform width and optionally a constant pitch for the majority of the exterior winding surface 386 to accommodate wrapping the tether 130 in an accumulating pattern within the continuous groove. In one embodiment, the pitch of the grooves is approximately 38 millimeters and the width of the groove is approximately 27 millimeters. Due to dynamic deployment and reception conditions (e.g., gusts of wind, turbulence, etc.), the width and/or pitch of these grooves may not accommodate fleeting angles in excess of a few degrees without the use of a levelwind. However, by using a flanged groove (e.g., fleeting angle groove 388) with a pitch that is substantially larger than the width of the continuous groove used for winding the tether around the exterior winding surface 386 of the drum 380, much greater fleeting angles can be accommodated without the use of a levelwind. For example, fleeting angles of plus or minus 15 degrees may be accommodated without the use of a levelwind. In some embodiments, the width of the flanged groove may be approximately 10 centimeters to 20 centimeters. Others widths may be used as well, depending on the implementation. In some embodiments, the flanged groove 388 may vary in width from start to finish. Although the flanged groove 388 is depicted in FIGS. 3 and 4 in a manner that is parallel to the winch drum 380, the flanged groove 388 may also be implemented at an angle with respect to the winch drum 380.

When the ground station 350 deploys (or launches) the aerial vehicle 320 for power generation via crosswind flight, the tether 330 may be unwound from the drum 380. In one example, one or more components of the ground station 350 may be configured to pay out the tether 330 until the tether 330 is completely unwound from the drum 380 and the aerial vehicle is in crosswind flight. The perch platform 372 may rotate about the top of the tower 352 so that the perch panel 358 is in proper position when the aerial vehicle is 320 is landing.

As shown in FIG. 4, the perch panel 358 may be aligned with the tether 330 being guided through flanged groove 388 (and/or a levelwind) and onto a rotatable drum 380 that rotates about an axis 380a. In this manner, the perch panel 358 faces the fuselage 324 of the aerial vehicle 320 when it is landing. The vertical drum 380 shown in FIGS. 3 and 4 has a central axis of rotation 380a. However a horizontal drum or an angled drum could also be used. For example, if a drum rotatable about a vertical axis is used, the perch panel support members 356 could be coupled to the drum such that the perch panel support members 356 extend perpendicularly from the axis of the drum and the tether 330 is wound onto the drum over the perch panel 358. In this manner as the tether 330 is wound onto the drum, the perch panel 358 will always face the aerial vehicle 320 and be in position to receive the peg 329 on the fuselage 324 of the aerial vehicle 320.

### III. ILLUSTRATIVE SYSTEMS AND METHODS FOR AN ACTIVE AZIMUTH GROUND STATION

FIG. 6 illustrates a cross sectional view of a portion of a ground station 650, according to some embodiments. The ground station 650 may be the same as, or similar to, those described in reference to FIGS. 1-5. The ground station 650 generally includes a tower 652, a platform 672 rotatable relative to the tower about an azimuth axis 672a, an azimuth slewing bearing 674, an azimuth drive motor 676, perch support arms 656, perch panel 658, a winch frame 690, a sealable maintenance door 692, a winch drum 680 rotatable about a central axis 680a, a winch drum slewing bearing 681, a winch drum drive motor 682, a gimbal mount 683, a gimbal 684, a conical interior surface 685, an exterior winding surface 686 with a constant pitch continuous groove 687, and a flanged groove 688.

In some embodiments, the azimuth slewing bearing 674 (described further in reference to FIG. 7) may be coupled to the platform 672 and the tower 652. One or more drive motors, such as an azimuth drive motor 676, may be coupled to the slewing bearing and configured to rotate the platform about an axis, such as an azimuth axis 672a.

The ground station 650 may also include a winch frame 690 coupled to the platform 672. The winch frame 690 may include various features. In some embodiments, a portion of winch frame 690 may include an exterior shell surrounding an interior cavity 691. The interior cavity 691 may be designed to safely house electronics and equipment (e.g., for environmental protection from rain, snow, ice, wind, corrosion, etc.). In one embodiment, interior cavity 691 of the winch frame 690 is configured to house all drive motors (e.g., the azimuth drive motor 676 and the winch drum drive motor 682) and most or all of the electronic components of the ground station 650. In some embodiments, the winch frame 690 may include a maintenance door 692 configured to provide access to the interior cavity 691. This maintenance door 692 may be sealed to assist with safely housing electronics and equipment. In a further aspect, the maintenance door 692 may be large enough to accommodate human entry into the interior cavity 691 of the winch frame 690 (e.g., for maintenance and repair purposes).

The ground station 650 may include a winch drum 680 that is rotatable relative to the winch frame 690. For example, a winch drum slewing bearing 681 (slewing bearings are generally described in reference to FIG. 7) may be coupled to the winch drum 680 and the winch frame 690. One or more drive motors, such as winch drum drive motor 682, may be coupled to the winch drum slewing bearing 681 and configured to rotate the winch drum 680 about an axis, such as a central axis 680a.

As depicted in FIG. 6, in some embodiments the winch drum 680 may be coupled to the winch frame 690 via a single point of contact, such as winch drum slewing bearing 681. This single-sided support is beneficial because it allows for free motion for components and/or maintenance on more of the platform. Further, the winch frame 690 can house all electronics and equipment as described herein.

In some embodiments, the winch drum may include an exterior winding surface, such as exterior winding surface 686. The exterior winding surface may be grooved such that the tether rests substantially within the groove when wound and unwound about the winch drum 680. This groove may have a particular pitch to facilitate winding and unwinding of the tether. For example, the groove may be a continuous groove with a constant pitch. Likewise, the groove may be continuous groove with a varying pitch. Other embodiments are possible.

In some embodiments, the winch drum 680 may include an interior surface forming a boundary of an interior drum cavity. For example, FIG. 6 depicts a conical interior surface 685 forming a boundary of an interior drum cavity. The conical interior surface 685 can serve various purposes. For example, as shown in the illustrative embodiment of FIG. 6, the conical interior surface 685 forms a boundary of an interior drum cavity and provides improved operational characteristics relative to other drum designs. For example, in comparison to a cylindrical drum, the winch drum 680 with the conical interior surface 685 has less material and thus less mass. Thus, the interior cavity provides a higher efficiency for the ground station 650 due to the lower inertia of the winch drum 680, which in turn means the winch drum 680 may be rotated using less energy.

In some embodiments, a gimbal mount 683 may be coupled to the winch drum 680. By shaping the gimbal mount 683 in an angled configuration, a portion of the gimbal mount 683 may be mounted within the interior cavity of the drum 680 as shown in FIG. 6. This also leads to improved center of gravity characteristics by a higher portion of the ground station 650 mass closer to the center of gravity of the rotatable portion. This also improves space use in packaging.

In some embodiments, the winch drum 680 may include (or be coupled to) a flanged groove 688. By using the flanged groove 688, a levelwind may be unnecessary as described above in reference to FIG. 3. During deployment of the aerial vehicle, the platform 672 may rotate about the azimuth axis 672a and the winch drum 680 may rotate about the central axis 680a such that the tether is unwound from the winch drum in a smooth fashion. Even with a levelwind, the flanged groove 688 provides the benefit of guiding the tether more gently into the groove. Similarly, during landing (or perching) of the aerial vehicle, the platform 672 may rotate about the azimuth axis 672a and the winch drum 680 may rotate about the central axis 680a such that the tether is wound about the winch drum 680 in a repeating pattern (e.g., within the grooves of the exterior winding surface 686). In combination with the flanged groove 688, the platform 672 may rotate about an axis (e.g., the azimuth axis 672a) to accommodate high relative fleeting angles. For example, the flanged groove 688 may be configured such that lateral bias from the tether on the flanged groove 688 (e.g., from a change in the azimuth angle of the tether relative to a planar axis normal to the winch drum) may cause the platform 672 to rotate around the axis (e.g., the azimuth axis 672a) towards the direction of the lateral bias.

FIG. 7 depicts an exploded view of a slewing bearing, according to some embodiments. The slewing bearing may include the bearing track 774, bearing teeth 775, a motor 776, a motor drive pinion 777, a housing 778, and a housing aperture 779. The motor 776 may include the motor drive pinion 777 and be configured to couple to the housing 778 via the housing aperture 779 such that the protrusions on the motor drive pinion 777 engage with the bearing teeth 775 of the bearing track 774. Thus, operation of the motor 776 causes the bearing track 774 to rotate. In some embodiments more than one drive motor (e.g., motor 776) may be used with each slewing bearing. In a further aspect, the drive motor may be hydraulic or electric and may use a gearbox.

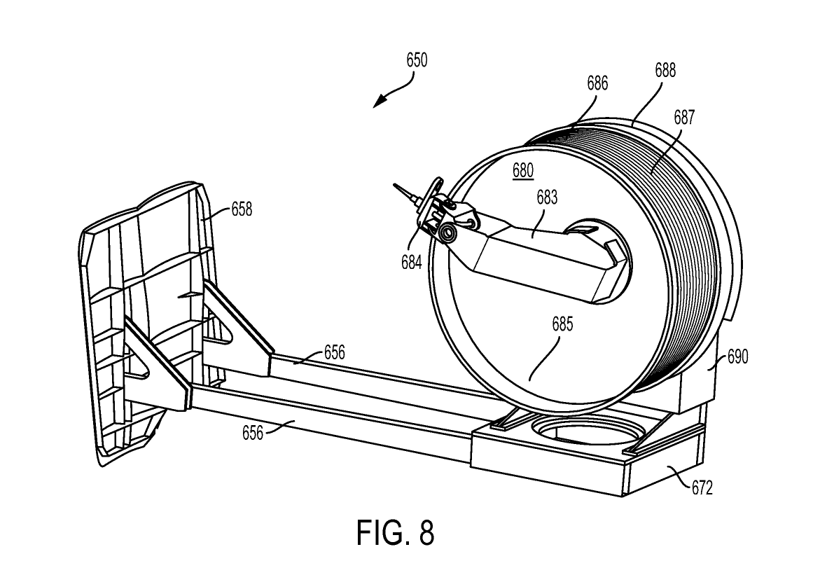

FIG. 8 illustrates a perspective view of a portion of a ground station 650, according to FIG. 6. The ground station 650 may be the same as, or similar to, those described in reference to FIGS. 1-6 and may contain the same or similar components that operate in the same or a similar manner as those described in reference to FIGS. 1-7. The ground station 650 generally includes a tower 652, a platform 672 rotatable relative to the tower about an azimuth axis 672a, perch support arms 656, perch panel 658, a winch frame 690, a winch drum 680 rotatable about a central axis 680a, a gimbal mount 683, a gimbal 684, a conical interior surface 685, an exterior winding surface 686 with a constant pitch continuous groove 687, and a flanged groove 688.

### IV. CONCLUSION

The above detailed description describes various features and functions of the disclosed systems, devices, and methods with reference to the accompanying figures. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A ground station, comprising:
a tower;
a platform rotatable relative to the tower via an azimuth slewing bearing;
at least one azimuth drive motor coupled to the azimuth slewing bearing and configured to rotate the platform about an azimuth axis;
a winch frame coupled to the platform;
a winch drum rotatable relative to the winch frame via a winch slewing bearing; and
at least one winch drive motor coupled to the winch slewing bearing and configured to rotate the winch drum about a central axis;
wherein the winch frame comprises an interior cavity configured to house the at least one azimuth drive motor and the at least one winch motor.

2. The ground station of claim 1, further comprising:
a tether adapted to be wound about the winch drum when the winch drum is rotated in a first direction about the central axis;
wherein the ground station is configured to rotate (i) the platform about the azimuth axis and (ii) the winch drum about the central axis, such that the azimuth and central rotations accumulate the tether on the winch drum in a repeating pattern.

3. The ground station of claim 2, wherein the winch drum further comprises a grooved surface about which the tether winds, and wherein the ground station is configured to rotate (i) the platform about the azimuth axis and (ii) the winch drum about the central axis, such that the tether accumulates in the grooved surface of the winch drum.

4. The ground station of claim 1, wherein the platform further comprises a perch panel configured to receive an aerial vehicle in a perched configuration.

5. The ground station of claim 1, wherein the winch frame further comprises a sealable maintenance door configured to provide access to the interior cavity.

6. The ground station of claim 1, further comprising:
a levelwind rigidly coupled to the platform, wherein a tether passes through the levelwind during winding, wherein the levelwind is configured to position the tether such that the tether is wound onto the winch drum and accumulates on the winch drum in a repeating pattern.

7. The ground station of claim 2, further comprising:
a gimbal mount coupled to the winch drum; and
a gimbal coupled to (i) the gimbal mount and (ii) the tether;
wherein the gimbal is rotatable about one or more axes.

8. A ground station, comprising:
a platform;
a winch frame coupled to the platform;
a winch drum coupled to the winch frame on a single side via a winch slewing bearing, wherein the winch drum is rotatable relative to the winch frame via the winch slewing bearing;
at least one winch drive motor coupled to the winch slewing bearing and configured to rotate the winch drum about a central axis;
wherein the winch drum comprises:
an exterior winding surface comprising a continuous groove with a substantially constant pitch; and
a tether adapted to be wound about the winch drum and accumulated in the continuous groove of the exterior winding surface when the winch drum is rotated in a first direction about the central axis.

9. The ground station of claim 8, wherein the winch frame comprises (i) an interior cavity and (ii) a sealable maintenance door configured to provide access to the interior cavity.

10. The ground station of claim 9, wherein the interior cavity is configured to house the at least one azimuth drive motor and the at least one winch motor.

11. The ground station of claim 8, wherein the winch drum further comprises a conical interior surface forming a boundary of an interior drum cavity.

12. The ground station of claim 8, further comprising:
a levelwind rigidly coupled to the platform, wherein a tether passes through the levelwind during winding, wherein the levelwind is configured to position the tether such that the tether is wound onto the winch drum and accumulates on the winch drum in a repeating pattern.

13. The ground station of claim 8, further comprising:
a gimbal mount coupled to the winch drum, wherein the gimbal mount is configured to rotate with the winch drum and wherein the gimbal mount is mounted substantially within the interior drum cavity; and
a gimbal coupled to (i) the gimbal mount and (ii) the tether;
wherein the gimbal is rotatable about one or more axes.

14. A ground station, comprising:
a tower;
a platform rotatable relative to the tower via an azimuth slewing bearing;
at least one azimuth drive motor coupled to the azimuth slewing bearing and configured to rotate the platform about an azimuth axis;
a winch frame coupled to the platform;
a winch drum rotatable relative to the winch frame via a winch slewing bearing;
at least one winch drive motor coupled to the winch slewing bearing and configured to rotate the winch drum about a central axis;
wherein the winch drum comprises:
an exterior winding surface comprising a continuous groove with a substantially constant pitch; and
a fleeting angle groove, wherein the width of the fleeting angle groove is substantially larger than the width of the continuous groove of the exterior winding surface; and
a tether adapted to be wound about the winch drum and accumulated in the continuous groove of the exterior winding surface when the winch drum is rotated in a first direction about the central axis.

15. The ground station of claim 14, wherein the winch frame further comprises (i) an interior cavity and (ii) a sealable maintenance door providing access to the interior cavity.

16. The ground station of claim 15, wherein the interior cavity is configured to house the at least one azimuth drive motor and the at least one winch motor.

17. The ground station of claim 13, further comprising:
a gimbal mount coupled to the winch drum; and
a gimbal coupled to (i) the gimbal mount and (ii) the tether;
wherein the gimbal is rotatable about one or more axes.

18. The ground station of claim 14, wherein the winch drum further comprises a conical interior surface forming a boundary of an interior cavity.

19. The ground station of claim 14, further comprising an aerial vehicle coupled to the tether.

20. The ground station of claim 14, wherein the platform further comprises a perch panel configured to receive an aerial vehicle in a perched configuration.
